(19) United States
(12) Patent Application Publication
(10) Pub. No.: US 2026/0170331 A1
(43) Pub. Date: Jun. 18, 2026

(54) SYSTEM AND METHOD FOR PREDICTING A PHYSICAL FIELD

(71) Applicant: Vinci4D.ai, Inc., Palo Alto, CA (US)

(72) Inventors: Hardik Kabaria, Palo Alto, CA (US); Sarah Osentoski, Palo Alto, CA (US)

(73) Assignee: Vinci4D.ai, Inc., Palo Alto, CA (US)

(21) Appl. No.: 19/425,304

(22) Filed: Dec. 18, 2025

Related U.S. Application Data
(60) Provisional application No. 63/735,758, filed on Dec. 18, 2024.
(60) Provisional application No. 63/735,799, filed on Dec. 18, 2024.

(51) Int. Cl. G06N 3/08

(52) U.S. Cl. CPC G06N 3/08

(57) ABSTRACT

The method can include determining a physical problem; determining an initial solution for the physical problem description; determining a final solution of the physical problem description, using the initial solution as a seed; optionally training a machine learning model based on the final solution. The method functions to quickly determine a high-quality solution (e.g., accurate and/or precise solution) to a physical problem by leveraging a predictive machine learning model for determining initial approximate solutions to the physical problem.

### CROSS-REFERENCE TO RELATED APPLICATIONS

This application claims the benefit of U.S. Provisional Application No. 63/735,758 filed 18 Dec. 2024 and 63/735,799 filed 18 Dec. 2024, each of which is incorporated in its entirety by this reference.

### TECHNICAL FIELD

This invention relates generally to the physical modeling field, and more specifically to a new and useful iterative, machine-learning based solving process in the computational modeling field.

### BRIEF DESCRIPTION OF THE FIGURES

FIG. 1 is a schematic representation of a variant of the method.

FIG. 2 is a schematic representation for a variant of the iterative solving process for finding a final solution.

FIG. 3 is a schematic representation for a variant of determining a solution using hierarchal components.

FIG. 4 is a schematic representation for a variant of training a machine learning solver.

FIG. 5 is a schematic representation for a variant of training a machine learning solver by determining various loss terms.

### DETAILED DESCRIPTION

The following description of the embodiments of the invention is not intended to limit the invention to these embodiments, but rather to enable any person skilled in the art to make and use this invention.

### 1. Overview

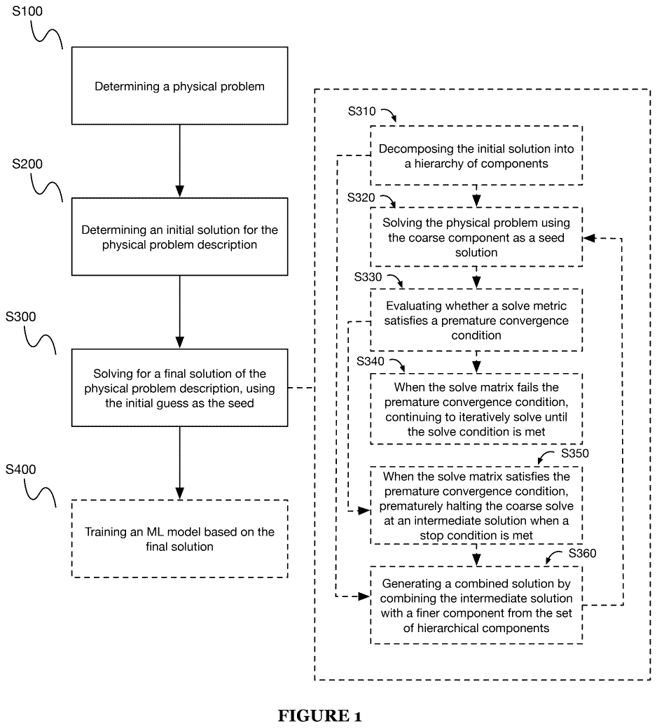

As shown in FIG. 1, in variants, the method can include determining a physical problem S100; determining an initial solution for the physical problem description S200; determining a final solution of the physical problem description, using the initial solution as a seed S300; optionally training a machine learning model based on the final solution S400; and/or be otherwise performed.

In an illustrative example, the method can include: determining a description of a physical problem (e.g., including an object geometry, boundary conditions, material properties, etc.); predicting an initial physical solution based on the physical problem description using a machine learning model; decomposing the initial physical solution into a coarse and find component; performing a coarse solve of the physical problem by seeding a numerical solver with the coarse component; if a solve metric indicates that the coarse solve has substantially converged (e.g., solution change or residual norm is less than a threshold) by the time a stop condition is met (e.g., 100 numerical solver iterations, etc.), prematurely halting the coarse solve and a performing a fine solve of the physical problem by seeding the numerical solver with a hybrid solution using the premature result of the coarse solve and the fine component, and prematurely halting the fine solve at the final solution if the solve metric indicates that the fine solve has substantially converged (e.g., solution change or residual norm is less than a second threshold) by the time a second stop condition is met (e.g., 50 numerical solver iterations, etc.). If the solve metric indicates that the coarse and/or fine solves have not substantially converged, then the coarse and/or fine solve is not prematurely halted, and the numerical solver determines a final solution to the physical problem.

In variants, the machine learning model can be trained against the final solution output by the numerical solver (e.g., using the full solve or the prematurely-halted solve). In further variants, the machine learning model can be trained using both a data loss (e.g., by comparing the predicted physical field against the final physical field) and a physics-based loss (e.g., by comparing both sides of the governing physical equations).

### 2. Technical Advantages

Variants of the technology can confer one or more advantages over conventional technologies.

First, the hybrid nature of variants of the technology—integrating machine learning with numerical solvers—confers the complementary advantages of both approaches. Machine learning provides rapid, data-driven initial predictions, while numerical solvers ensure these predictions are refined to achieve high accuracy. This integration enables faster, more efficient solutions across a wide range of physical systems, including structural mechanics, fluid dynamics, and other computational physics applications. An ML-based initial solution provides a robust seed for numerical solvers, accelerating convergence and enabling adaptability across diverse problem domains. The combination of both approaches results in a powerful solver that determines accurate solutions quicker and more efficiently than either approach used individually.

Second, variants of the technology can confer benefits provided by applying machine learning models to physical field solves. By generating an ML-based initial guess, variants of this technology leverage ML's ability to handle large datasets, quickly predict solutions, and learn complex variable relationships. The use of ML models allows variants of the technology to handle complex mathematical relationships without needing to explicitly define or solve these relationships. Additionally, ML models can make predictions based on these learned relationships quickly and efficiently. The use of ML models can result in variants of the technology that quickly determine initial solutions based on complex variable relationships.

Third, variants of the technology can further improve solution computation efficiency and speed by decomposing the initial solution into a hierarchy of components (e.g., at different scales or frequencies), performing a coarse solve using a coarse component of the solution as a seed solution, prematurely halting the coarse solve at an intermediate solution when a solve metric changes less than a threshold amount (e.g., indicating that the coarse solve has substantially converged), then performing a fine solve using a hybrid solution formed by combining the intermediate solution with the fine solve as a seed. The fine solve can also be prematurely halted when the solve metric changes less than a threshold amount, wherein the resultant solution is treated as the final solution. Prematurely halting the solves can save on computational resources and time, resulting in high-quality solutions faster and using less compute than a conventional numerical solver. In variants, the solves (e.g., coarse solve, fine solve, etc.) can be continued using the numerical solver if the solve metric fails the premature convergence condition (e.g., changes more than a threshold amount) to ensure that a high-quality final solution is returned.

Fourth, variants of the technology integrate a physics-based loss function when training the ML model (e.g., in addition to data loss) to ensure that the ML-generated initial guess adheres to physical laws and system constraints. In some examples, the physics-based loss can use a preconditioned loss (e.g., using a preconditioning matrix), which can enable the ML model to be trained even when the associated physics PDEs are non-convergent. By combining data-driven learning with domain-specific knowledge, this approach enhances the plausibility and reliability of ML predictions while simultaneously refining the accuracy of numerical solutions.

Fifth, variants of the technology can improve the functioning of a computer or computational system itself. For example, the method dynamically evaluates one or more solve metrics during numerical solution of a physical problem to identify when a solver has substantially converged, and responsively halts further computation when a premature convergence condition is satisfied. This selective halting avoids unnecessary iterations that would otherwise consume computational time and resources without meaningfully improving solution accuracy. Furthermore, by integrating machine learning-based initial guesses with adaptive solver control logic, variants of the technology reduce the total number of computational cycles required to achieve high-quality physical field solutions. The selective halting and re-seeding process described herein represents a specific improvement to computer-based numerical solvers. Variants of the present technology employ real-time monitoring of solve metrics (e.g., residual norm, energy functional, or solution delta) to make dynamic decisions regarding solver termination and reseeding. This enables the computing system to allocate resources more efficiently—skipping redundant iterations, reducing memory access operations, and shortening wall-clock runtime—thereby improving overall computer performance during physical simulation or prediction tasks.

Sixth, variants of the technology further provide a practical application through the generation and utilization of non-human-readable embeddings, latent encodings, and multimodal representations that capture complex physical relationships beyond what can be mentally or manually determined. In particular, the machine learning model can encode heterogeneous and/or multimodal physical problem descriptions—including geometry, material properties, environmental parameters, and boundary conditions—into compact latent vectors or embeddings that quantitatively represent the interdependencies between physical parameters. These embeddings are non-symbolic data structures that have no human-interpretable meaning but are optimized for computational processing and inference. This enables the computing system to determine, represent, and manipulate complex multidimensional physical information using low-dimensional latent spaces that preserve relevant physical correlations. Conventional numerical solvers and symbolic encodings require explicit equation-based specification of every variable interaction, which can become computationally intractable for complex systems. By contrast, variants of the technology learn latent encodings that inherently represent coupled variable behavior—allowing the system to predict, generalize, and refine physical solutions without explicitly solving all governing equations. This improves computational tractability and enables faster, more accurate solutions to physical field problems.

However, further advantages can be provided by the system and method disclosed herein.

### 3. Method

As shown in FIG. 1, in variants, the method can include determining a physical problem S100; determining an initial solution for the physical problem description S200; determining a final solution of the physical problem description, using the initial solution as a seed S300; optionally training a machine learning model based on the final solution S400; and/or be otherwise performed. The method functions to determine a high-quality solution (e.g., accurate and/or precise solution) to a physical problem.

The method can be used to predict: structural fields (e.g., stress, strain, deflection, displacement, buckling, stability, fatigue, fracture, vibration, acoustics, etc.); thermal fields (e.g., temperature distribution, heat flux, thermal stress, thermal expansion, radiative heat transfer, etc.); fluid fields (e.g., fluid dynamics, fluid flow, pressure distribution, velocity, turbulence, heat transfer, etc.); electromagnetic fields (e.g., electric field, magnetic field, electromagnetic induction, microwave analysis, RF analysis, etc.); geotechnical or porous fields (e.g., pore pressure field, saturation field, permeability field, soil displacement, etc.); quantum fields (e.g., wavefunction fields, spin fields, electron density fields, etc.); acoustic fields; chemical or biological fields (e.g., reactant/product distribution; chemical potential field, pH or ionic fields, membrane potential field, tissue growth fields, etc.); nonlinear behaviors (e.g., with complex stress-strain relationships); optical characteristics (e.g., refraction, transmission, etc.); and/or other characteristics.

The high-quality, predicted physical fields determined by the method can be applied in a wide range of technical domains and computational workflows. In some variants, the predicted fields can be used to inform the design, optimization, or control of physical systems that depend on spatial or temporal field distributions. For example, the predicted field can represent one or more of: a temperature field, pressure field, stress or strain field, chemical concentration field, electric or magnetic potential field, velocity field, or any suitable scalar or vector field describing the state of a physical system. The predicted field can thus be used to inform engineering design decisions, boundary condition adjustments, or real-time control inputs to a physical apparatus. In some embodiments, the predicted physical fields can function as surrogate or reduced-order models for high-fidelity simulation tools. For example, the output of the machine learning model can be used to initialize, guide, or partially replace a finite-element or finite-volume solver, thereby reducing computational cost while maintaining accuracy.

In another set of variants, the predicted physical fields can be used to control or monitor physical devices or processes. For example, the predicted field can inform actuator settings, heat distribution control, structural reinforcement, chemical dosing parameters, fabrication processes (e.g., settings, etc.), and/or other processes. In electrochemical applications, the predicted field can represent ionic concentration or potential gradients across an electrode-electrolyte interface and can thus be used to optimize reaction uniformity, current density, or material utilization. In thermal management applications, the predicted field can represent heat flux or temperature gradients and can be used to dynamically control cooling or heating elements to maintain desired operating conditions. In structural mechanics, the predicted stress field can be used to identify load paths, failure regions, or to inform adaptive structural design.

Additionally, predicted fields can be integrated with digital twins, simulator, automated design loops, or reinforcement learning agents, where the predicted field serves as a differentiable proxy for real-world measurements. For example, the predicted field can be incorporated into a feedback controller that adaptively updates input parameters to achieve a target system response. This integration of data-driven field prediction into control, monitoring, and optimization workflows further exemplifies a practical application of the underlying machine learning model and computational method. The utilization of the predicted field for real-time applications is enabled by the speed and efficiency of the method.

The method can be performed when a new geometry is received, upon receipt of a request from a user (e.g., including a problem description and/or design, etc.) when a physical field of interest is determined, and/or at any other suitable time. For example, in variants in which a user is designing and/or a modeling a physical system, the method can be performed after the properties, constraints, geometry, and other parameters of the physical system and/or problem is defined. The method can be performed using a computing system, processor, graphics processing unit (GPU), cloud computing platform, supercomputer, and/or any other computing resource. The method can be performed by a remote computing system, local computing system, and/or any other suitable computing system.

In variants, the method can be used to determine a solution for a physical problem governed by one or more physics-based governing equations such as heat equations, Fick's laws, Wave equations, Maxwell's equations, Navier Stokes equations, Schrodinger equation, elasticity equations, reaction-diffusion equations, and/or any other physics-based governing equations. The method can be used to predict structural characteristics (e.g., stress, strain, deflection, displacement, buckling, stability, fatigue, fracture, vibration, acoustics, etc.); thermal characteristics (e.g., temperature distribution, heat flux, thermal stress, thermal expansion, etc.); fluid characteristics (e.g., fluid dynamics, fluid flow, pressure distribution, velocity, turbulence, heat transfer, etc.); electromagnetic characteristics (e.g., electric field, magnetic field, electromagnetic induction, microwave analysis, RF analysis, etc.); nonlinear behaviors (e.g., with complex stress-strain relationships); optical characteristics (e.g., refraction, transmission, etc.); and/or other characteristics for a design.

In variants, the method can be used to determine steady state and/or equilibrium physical fields. However, in variants the method can be used to determine non-equilibrium, dynamic, and/or transient physical fields.

In variants, the physical field can include a set of values describing a physical field in space. The physical field can be represented as a set of numerical data (e.g., values for each voxel, values for each of a set of points, etc.), a visualization (e.g., contour plot, shape, animation, data plot, color-coded plot, etc.), and/or otherwise represented. The physical fields can be predicted using geometric information (e.g., geometric representations such meshes, point clouds, signed distance functions, etc., geometric embeddings, geometric encodings, etc.), topological information, boundary conditions (e.g., Dirichlet, Neumann, Robin, etc.), source element information, material properties and/or physical properties, and/or any other relevant information. The predicted physical field can be in the same space or difference space as the design. In an example, the 3D design includes a CAD file or mesh, while the predicted physical field is in a voxelized space.

Determining a physical problem S100 functions to obtain the parameters and constraints for the physical problem. The physical problem can include the design (e.g., properties, geometry, constraints, boundary conditions, etc.) of a physical system, a theoretical system, a synthetic system, a simulated system, and/or any other system. The physical problem can be received from a user, retrieved from a repository, generated by a prior iteration of the method, synthesized, estimated using a different method, retrieved through a programmatic interface (e.g., an API, etc.), automatically generated (e.g., randomly generated, perturbed from a prior problem description, etc.), generated using artificial intelligence, and/or any other suitable determination method.

In an example, physical problems that can be described can include determining (e.g., solving, computing, estimating, predicting, etc.) stress, strain, thermal transfer, electromagnetic fields, fluid flow, and/or any other suitable physical problems. The physical problem can be defined by a physical problem description, and/or any other suitable definition method. The physical problem description can provide the parameters and conditions to fully define the physical problem (e.g., describe the object and physical environment acting upon the object), and/or include other information.

The physical problem can be associated with aerospace, automotive, mechanical engineering, structural engineering, oil and gas, chemical processing, electronics, computer engineering, semiconductors, chip design, material design, and/or any other industry. For example, the design can include designs for integrated circuit boards, computing systems (e.g., including boards, heatsinks, fans, etc.), industrial systems (e.g., piping networks, pressure vessels, turbines), building components (e.g., support beams, HVAC systems, etc.), consumer electronics, chemical processing systems, automotive parts (e.g., engines chassis frames), aerospace components (e.g., wing structures, fuel tanks, etc.), robotic assemblies, renewable energy systems (e.g., wind turbines, solar panels, etc.), enclosures, devices, and/or any other suitable design. The design can include a set of information (e.g., parameters, coefficients, measurement, etc.) that can be used to determine a physical field.

The physical problem description can include the object geometry, material properties, environment properties, boundary conditions (e.g., Dirichlet, Neumann, Robin, etc.), loading conditions and/or source elements (e.g., applied stimuli, such as stimuli kinematics, stimuli location, etc.), physics-based variable constraints, and/or any other suitable parameters. The physical problem description can additionally or alternatively include solving parameters (ex. solver settings, step size, meshing, solve conditions). The physical problem description preferably excludes governing equations for variable of interest (e.g., the physical parameter being solved for), but can alternatively include governing equations for variable of interest.

The object geometry can include geometries (e.g., solid geometry, surface geometry, curve geometry, etc.) and/or topologies (e.g., connectivity between geometric entities, orientation, etc.). The object geometry can be represented as a mesh, CAD design, voxel grid, point cloud, or any suitable geometric representation. The shapes and/or geometric features of the design can have at any length scale (e.g., subatomic-scale, atomic-scale, molecular-scale, nanometer-scale, micron-scale, meso-scale, millimeter-scale, centimeter-scale, macro-scale, meter-scale, etc.). A design can include shapes and/or geometric features of a single length scale or a plurality of length scales. In an example, the design can include geometric features with characteristic length scales that span between 1 and 10 magnitudes of length-scales (e.g. 1 magnitude, 2 magnitudes, 3 magnitudes, 4 magnitudes, 5 magnitudes, 6 magnitudes, 7 magnitudes, 8 magnitudes, 9 magnitudes, 10 magnitudes, or any range and/or value therebetween). In variants, the geometric representation can have different resolutions at different regions (e.g., to capture fine details at specific regions. For example, in variants in which the geometric representation is a point cloud or mesh, the geometric representation can include more points and/or more nodes in a specific region of the geometry. In another example, in variants in which the geometric representation is voxel grid, the geometric representation can include smaller voxel in a specific region of the geometry.

The material properties can be represented as a set of numerical data (e.g., values for points, voxels, volumetric segments of the design, etc.). Examples of material properties that can be used can include: mechanical properties (e.g., Young's modulus, Poisson's ratio, shear modulus, bulk modulus, yield strength, ultimate tensile strength, fracture toughness, density, etc.), thermal properties (e.g., thermal conductivity, heat capacity, thermal diffusivity, coefficient of thermal expansion, melting point, etc.), electrical properties (e.g., electrical conductivity, electrical resistivity, dielectric constant and/or permittivity, breakdown voltage, piezoelectric coefficients, permeability, magnetization, etc.), fluid properties (e.g., viscosity, compressibility, surface tension, etc.), optical properties (e.g., refractive index, absorption coefficient, etc.), particulate properties (e.g., diffusion coefficient, mass diffusivity, thermal expansion coefficient, etc.), and/or any other material properties.

The source elements (e.g., heat source, mass source, forces, charge sources, etc.) can be used to describe external or internal physical influences on the design. For example, source elements can drive physical field responses in the design. Source elements can be represented as a set of numerical data (e.g., values for voxels, values for sets of points, values for geometric segments, etc.), a visualization (e.g., contour plot, shape, animation, data plot, color-coded plot, etc.), and/or otherwise represented. However, the design can be otherwise defined.

However, determining a physical problem S100 may be otherwise performed.

Determining an initial solution for the physical problem description S200 functions to determine an initial solution using a machine learning model 100 (e.g., bypassing slow and computationally intensive numerical solves). S200 can be performed after a physical problem and/or design is received, defined, retrieved, and/or otherwise determined (e.g., after S100). S200 can function to determine an initial solution (e.g., initial prediction, etc.) that can be closer to the final solution to seed the numerical solver such that the numerical solver can solve for the final solution much faster. The initial solution can function as a starting point for the numerical solver, and/or can function in any other suitable manner. The initial solution can be determined using any suitable method and/or can have any suitable relationship to the final solution.

S200 can include computing, calculating, predicting, inferring, estimating, and/or any other suitable method for determining the initial solution for the physical problem description. S200 can be performed using a machine learning model, numerical solver, and/or any other module.

The initial solution is preferably a full solution, but can alternatively be a partial solution (e.g., only include coarse components of the solution, only include fine components of the solution, only include a solution for half the geometry, only include a subset of frequencies and/or modes, have a limited resolution, etc.), and/or any other suitable solution type.

The initial solution (e.g., initial field prediction) can be represented as a set of numerical data (e.g., values for each voxel, values for each of a set of points, values for each of a set of edges, values for each simplex, etc. ; as a vector, a matrix; etc.), a visualization (e.g., contour plot, shape, animation, data plot, color-coded plot, etc.), and/or otherwise represented. The initial solution can be discretized, continuous, or have any suitable form. In variants the initial solution can have the same resolution, discretization, size, dimensionality, and/or structure, as a final field prediction, or a different resolution, discretization, size, dimensionality, and/or structure. The discretization can be uniform or nonuniform.

In a first variant, S200 can include predicting the initial solution using a machine learning model 100. The machine learning model can be a multilayer perceptron, neural network, deep neural network, convolutional neural network (CNN), recurrent neural network (RNN), graph neural network (GNN), transformer, autoencoder, neural network with a set of self-attention layers or cross attention layers, and/or any other suitable machine learning model.

The models can be trained using supervised learning, unsupervised learning, semi-supervised learning, reinforcement learning, transfer learning, and/or any other training method. The machine learning model can be trained to predict a solution (e.g., a physical field) to the physical problem. The machine learning model can be trained end-to-end, piecewise (e.g., encoding layers are trained independently of the decoding layers), or otherwise trained. The machine learning model can be trained using a set of training physical problem descriptions paired with their respective physical field solutions as training targets. The target physical field solutions can be determined using numerical solvers, empirically (e.g., measured), using the method described herein (e.g., S400), and/or any other suitable determination method.

The machine learning models can be trained on one or more losses (e.g., concurrently, serially, interchangeably, etc.). Examples of losses that the machine learning model(s) can be trained against include: a data-based loss (e.g., loss computed by comparing the predicted output and a ground-truth value, etc.), physics-based loss (e.g., PDE loss, raw physics based loss, preconditioned loss, matrix-based preconditioned loss, loss computed using the governing partial differential equations for the physical characteristic, a loss function that penalizes violation of physics-based constraints; etc.), gradient-based losses (e.g., gradient difference loss, gradient norm loss, Jacobian loss, seminorm losses, etc.), regression losses (e.g., MSE, MAE, Huber loss, quantile loss, etc.), classification losses (e.g., binary classification, multiclass classification, etc.), ranking losses (e.g., contrastive loss, triplet loss, etc.), divergence losses, autoencoder losses, normal consistency, Laplacian loss, cross-entropy losses, hybrid loss, and/or any other losses. For example, the preconditioned loss can be a physics-based loss that applies a PDE-derived matrix (e.g., derived from pieces of the discretized operator) and/or other preconditioners to the raw physics-based loss (e.g., PDE loss, physics residual, etc.) to enforce the physics more accurately, and/or be otherwise preconditioned. Examples of preconditioners (e.g., preconditioning matrices) that can be used can include: multigrid preconditioners, block preconditioners, ILU/IC preconditioners, physics based preconditioners (e.g., diffusion only operators, linear elasticity operators, diagonal mass matrices, etc.), null-space aware preconditioners, and/or other preconditioners. Additionally or alternatively, the numerical solver can use preconditioning matrices when determining the corrected coarse-scale component and/or corrected final field. The physics based loss can be determined from a comparison between: the initial solution and the final solution; from a comparison between the initial solution and an independently PDE-solved solution; and/or a comparison between the initial solution and any other target solution (e.g., target physical field).

In this variant, the physical problem description (e.g., geometry, properties, boundary conditions, etc.) can be passed as input(s) to the machine learning model. The input can be ingested by the model through multiple channels (e.g., different input channels for different data types, etc.), a single channel, and/or in any other method. The machine learning model can output a predicted physical field (e.g., as an initial solution to the physical problem).

In a second variant, S200 can include determining the initial solution using a simplified physical problem description. The simplified physical problem description can include a basic or reduced form of the full physical problem that is quicker to solve than the original physical problem, and/or any other suitable form. For example, the simplified problem description can have a reduced number of constraints, boundary conditions, source elements, and/or any other components. In another example, the simplified problem description can be downsampled (e.g., resulting in fewer data points to describe the system). In this example, the initial solution can have a lower resolution than a desired final solution. However, a simplified physical problem can be otherwise determined. In variants, the initial solution can be determined by a numerical solver based on the simplified physical problem description. However, the initial solution to the simplified physical problem can be otherwise determined.

In a third variant, S200 can include determining the initial solution using a mapping function. The mapping function can be based on geometry, material properties, boundary conditions, and/or any other parameter. For example, a mapping function can be used to estimate a field based on the geometry. In one embodiment, a mapping function can describe that a physical field value is larger at points that have fewer nearest neighboring points. That is, the initial solution to a physical field is defined by a relationship that correlates the characteristic size of geometric features to a field's strength. In a second embodiment, a mapping function can correlate a relationship between material properties to a physical field strength. For example, the mapping function might define that higher conductivity of materials of the physical design correlate with stronger fields. The mapping function can be manually determined (e.g., using domain knowledge and/or expertise, etc.), estimated, derived, and/or otherwise determined. However, a mapping function can be otherwise defined.

In a fourth variant, S200 can include randomly determining the initial solution, wherein randomly determining can include guessing, sampling randomly, and/or any other suitable random determination methods.

However, determining an initial solution for the physical problem description S200 may be otherwise performed.

Determining a final solution of the physical problem description using the initial solution as a seed S300 functions to solve for the physical parameters and/or physical field of interest (e.g., using the seed to increase efficiency and/or speed). In variants, S300 can function to iteratively solve for the final solution using successively finer components of the initial solution. The final solution can be a solution to the physical problem description that is proximal (e.g., substantially similar, equivalent to, etc.) to the physics ground truth, but can alternatively be defined in any other suitable manner. In variants, the final solution can be verified experimentally, computationally (e.g., evaluating the physics loss, evaluating whether the solution solves the governing equations for the physical parameter, etc.), otherwise verified, and/or remain unverified

S300 can be performed using a numerical solver 300, a second machine learning model (e.g., trained to solve for a given solution coarseness, etc.), and/or any other suitable solver. The numerical solver can be an iterative solver, direct solver, and/or any other suitable solver type. In examples, numerical solvers that can be used can include: a Jacobi solver, Gauss-Seidel solver, conjugate gradient solver, GMRES solver, multigrid methods, gaussian elimination, LU decomposition, sparse direct solver, eigenvalue-specific solvers, and/or any other suitable numerical solvers.

In variants, the initial solution (e.g., from S200) can be used as a seed solution for the solver 300. The seed for the solver can include the starting point for the numerical solver, can be used to initialize the solver, and/or any other suitable seed solution usage. In other variants, components (e.g., fine components, coarse components) of the initial solution can be used as a seed for the numerical solver 300.

The final solution can be substantially different from the initial solution, similar to the initial solution, or be otherwise related to the initial solution. This difference can be quantified by a residual, error, percentage error, loss, and/or any other metric. The difference can be used to train the machine learning model (e.g., predicting the initial solution), or otherwise used. In variants, the final solution and initial solution can have the same data structure, resolution, discretization, dimensionality, and/or other traits. However, in other variants, the final solution and initial solution can have different data structures, resolutions, discretization, dimensionalities, and/or any other trait.

Iterative solving can include solving the physical problem using a coarse component as a seed, prematurely halting the solve when the solution has substantially converged (e.g., when a premature convergence condition is met), and repeating the process using a hybrid solution formed from the coarse solution and successively finer components as the seed. However, the final solution can be otherwise determined.

In variants, S300 can include: decomposing the initial solution into a hierarchy of components (e.g., using a decomposition module 200) S310; solving the physical problem using the coarse component as a seed solution S320; evaluating whether a solve metric satisfies a premature convergence condition S330; when the solve metric fails the premature convergence condition, continuing to iteratively solve until the solve condition is met S340; when the solve metric satisfies the premature convergence condition, prematurely halting the coarse solve at an intermediate solution when a stop condition is met S350; generating a combined solution by combining the intermediate solution with a finer component from the set of hierarchical components S360 (e.g., using a reconstruction module 300); and determining the final solution by repeating S320-S350 using the combined solution as a seed for the numerical solver S370.

Decomposing the initial solution into a hierarchy of components S310 functions to transform the initial solution into subcomponents that can be quicker and more efficient to solve. The hierarchy of components can include iteratively finer components. In an example, the hierarchy can include a coarse component and a fine component, but can alternatively include intermediate components at intermediate coarseness and/or resolutions. For example, the hierarchy of components can include two resolutions (e.g., fine and coarse, dominant and residual, etc.), three resolutions (e.g., fine, medium, coarse), four resolutions, five resolutions, and/or any suitable amount of resolutions.

In variants, the components can be represented as component fields, basis coefficients and/or weights, a frequency-domain representation of the initial solution, and/or any other suitable representation. The components can be determined from a performing a multi-resolution transform on the initial solution.

The components can be in the spatial domain (e.g., scale domain, geometry domain, etc.), frequency domain, and/or any other suitable domain. In variants, the decomposing the initial solution can include performing a frequency-based transformation, a spatial decomposition, a modal decomposition, a statistical decomposition, data-driven decomposition, and/or any other suitable transformation or decomposition. For example, S310 can be decomposed using Fourier transforms, wavelet transforms, multigrid decomposition, multiscale decomposition, normal mode decomposition, discrete cosine transform, multi-resolution analysis, Gaussian pyramid decomposition, Laplacian pyramid decomposition, wavelet packet decomposition, variational mode decomposition, empirical mode decomposition, principal component analysis, dynamic mode decomposition, singular value decomposition, basis function decomposition, proper orthogonal decomposition, FEA filtering, residual-based filtering, and/or any other suitable decomposition methods.

S310 can include transforming a function into a set of daughter functions that when recombined, cooperatively form the original function. A coarse component can include a daughter function that captures the broad and large elements of the original function. A fine component can include a daughter function that captures the fine and specific fluctuations of a function, and/or any other suitable components.

In a first variant, the initial solution can be decomposed in the frequency domain. The initial solution can be transformed into a frequency domain (e.g., using a Fourier transform, wavelet transform, discrete cosine transform, etc.). The solution can be decomposed in the frequency domain into different frequency bands (e.g., low frequency components can be treated as coarse components, while high frequency components can be treated as fine components). The frequency-based decomposition can be performed using filters (e.g., high-pass and loss-pass filters), clustering techniques, and/or any other suitable techniques. In variants, the filtering and/or clustering techniques can be tuned to achieve components that can be efficiently handled by a numerical solver. For example, components with a frequency higher than a predetermined threshold may be excluded from the coarse component. This predetermined threshold can be learned, tuned, modified, and/or otherwise determined. In an example, S310 can include finding the Fourier transform of the initial solution and passing the transformed-function through a high-pass and low-pass filter. In another example, S310 can include applying a discrete wavelet transform to decompose the initial solution into a fine and coarse component. In a second variant, S310 can include decomposing the initial solution in the spatial domain. The initial solution can be decomposed by sampling the solution at different sampling densities for different coarseness levels. In an example, a high-pass and low-pass filter can be applied to the initial solution to obtain a fine and coarse component, and/or any other suitable decomposition method can be applied.

However, decomposing the initial solution into a hierarchy of components S310 may be otherwise performed.

Solving the physical problem using the coarse component as a seed solution S320 functions to solve for a final solution using a subset of the initial solution, which can increase computational speed and decrease computational complexity. S320 can be performed using a solver 400 (e.g., numerical solver), analytical methods, semi-analytical methods, experimental methods, and/or any other suitable methods. The numerical solver is preferably an iterative solver, but can alternatively be a direct solver, and/or any other suitable solver.

S320 can determine new solutions (e.g., iterative solutions, intermediate solutions, etc.). S320 preferably iteratively determines the new solutions, but can alternatively determine the new solution in a single step. Iteratively solving can include progressively converging to the final solution, starting from the coarse solution, by iteratively determining new solutions that converge on the final solution. S320 can use linear solver methods (ex: Jacobi, Gauss-Seidel, Conjugate gradient), nonlinear solver methods (ex: Newton-Raphson, fixed point iteration), or other methods, like gradient descent, Newton's method, finite difference, and/or any other suitable methods.

In a specific example, S320 can include initializing the solver with the coarse component as the seed (the first iterative solution). The solver can use a numerical method (such as Newton-Raphson method) to determine a new iterative solution. S320 can include finding the difference between the new iterative solution and the previous iterative solution. The solve can be repeated using any other suitable conditions, solvers, seeds, methods, and/or algorithms.

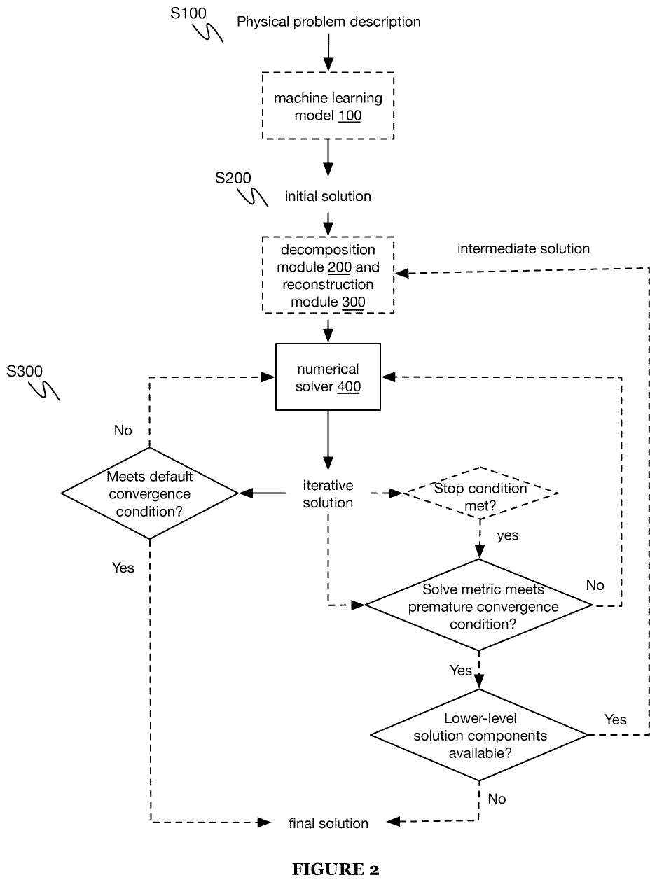

S320 can include repeating the solve (e.g., iteratively determining a new solution starting from the prior solution) until a premature convergence condition is met by a solve metric, until a default convergence condition is met by a solve metric, until a stop condition is met (e.g., wherein the default convergence condition is stricter than the premature convergence condition), and/or until any other suitable condition is met, example shown in FIG. 2. The solve metrics can include residual norm, solution update, objective function, relative error, potential energy, functional, time step convergence, multi-domain consistency, energy norm, solution change (e.g., solution delta between iterations), and/or any other suitable solve metrics. Examples of premature convergence conditions that can be used can include the solve metric falling below a threshold, the change in the solve metric value falling below a threshold, and/or any other suitable convergence conditions. Examples of stop conditions that can be used include: a predetermined number of solve iterations, a set of solve metrics satisfying a set of predetermined conditions, and/or any other stop condition.

However, solving the physical problem using the coarse component as a seed solution S320 may be otherwise performed.

Evaluating whether a solve metric satisfies a premature convergence condition S330 functions to determine whether the solve can be prematurely halted (e.g., determine that the solve has substantially converged) to determine if a condition is met to determine the method of reaching the final solution. S330 can be evaluated at each iteration (e.g., in S320), every M iterations (e.g., where M is a predetermined hyperparameter, etc.), when a solve metric evaluation is requested, at the stop condition, randomly, at a predetermined time interval, and/or any other suitable evaluation timing.

The solve metric that can be used in S330 can include residual norm, H1 seminorm, L2 norm, energy norm, functional error, H2 seminorm, relative residual norm, scaled residual norm, absolute error, relative error, gradient error norm, boundary condition mismatch, energy balance error, solution increment norm, governing equation residual, continuity equation residual, mean squared error, mean absolute error, and/or any other suitable solve metrics. The solve metric used in S330 can be the same as or different from the solve metric evaluated for the default convergence condition. In a first example, the solve metric for S330 can be the residual norm, while the solve metric for the default convergence condition can be a relative error.

The premature convergence condition can include the solve metric or change thereof falling below a threshold, the relationship between two solve metrics satisfying a predetermined relationship, and/or any other suitable condition. In a first example, the premature convergence condition can include the residual norm falling below a threshold. In a second example, the premature convergence condition can include the residual norm exceeding the solution change. The premature convergence condition for S330 is preferably looser (e.g., a higher threshold, an easier-to-satisfy condition, etc.) than the default convergence condition, but can alternatively be the same or tighter than the default convergence condition. The premature convergence condition can be manually specified, determined as a multiple of the default convergence condition, determined from literature, determined based on a target solution accuracy or precision, and/or any other suitable determination method.

In a first example, S330 can include comparing the solution delta to the residual norm to assess which is larger during each iteration in S320, and/or any other suitable evaluation methods. In a second example, the solution metric (e.g., residual norm) can be compared against a threshold (e.g., the premature convergence condition) after M iterations of S320 (e.g., 50, 100, 200, 300 solve iterations, etc.), and/or any other suitable number of iterations. However, evaluating whether a solve metric satisfies a premature convergence condition S330 may be otherwise performed.

Continuing to iteratively solve until the solve condition is met when the solve metric fails the premature convergence condition S340 functions to determine a high-quality final solution when the initial solution is far off from the final solution (e.g., as indicated by the solve metric failing the premature convergence condition). In examples, S340 can allow the numerical solver to continue solving until a final solution is reached (e.g., until the default convergence condition is met), and/or any other suitable solving continuation method. S340 can use the same solver settings or different solver settings (e.g., determined based on the solution change, the velocity of the solution change, a predetermined set of settings, etc.), and/or any other suitable solver settings. However, S340 may be otherwise performed.

When the solve metric satisfies the premature convergence condition, prematurely halting the coarse solve at an intermediate solution when a stop condition is met S350 functions to halt the coarse(r) solve seeded by the coarse(r) component when the coarse solution has substantially converged.

S350 is preferably halted before the default convergence condition is met (e.g., “prematurely halted”), but can alternatively be halted when the default convergence condition is met and/or at any other suitable time.

The intermediate solution can be the last iterative solution determined before halting the iterative solve, and/or any other suitable solution. The intermediate solution can be determined at any suitable point during the iterative solve process prior to complete convergence, and/or at any other suitable time during the solve process.

S350 is preferably halted when a stop condition is met, but can alternatively be halted when another condition is met. The stop condition is preferably based on a different solve metric from the convergence conditions, but can alternatively be based on the same solve metric. The stop condition can alternatively also require that the premature convergence condition be met. The stop condition can be time-dependent, iteration-dependent, and/or any other suitable condition type. Examples of stop conditions that can be used include: number of iterations, a predetermined time duration, a predetermined residual norm, and/or other solve metrics.

In a first example, the solve in S320 can be prematurely halted when the premature convergence condition is met and a predetermined number of solve iterations have been performed (e.g., 20, 50, 100, 200, 500, 1000 iteration of a solve seeded by the coarse component, etc.), and/or any other suitable number of iterations. The last iterative solution calculated before halting can be determined to be the quick solution. In a second example, S350 can include prematurely halting the solve in S320 when the premature convergence condition is met and when a threshold amount of clock time has passed (e.g., 30 seconds, 1 min, etc.), and/or any other suitable conditions.

S350 may include additional processing steps and calculations on the intermediate solution. The additional processing steps may include filtering, average, smoothing, normalizing, and/or any other suitable processing steps. However, S350 may be otherwise performed.

Generating a combined solution by combining the intermediate solution with a finer component from the set of hierarchical components S360 functions to leverage the information in finer components from the initial solution for determining a final solution. S360 can be performed using a reconstruction module S250. The finer component can be a component in the hierarchy (e.g., the next finer component), the last component in the hierarchy (e.g., the finest component, etc.), and/or any other suitable component in the hierarchy.

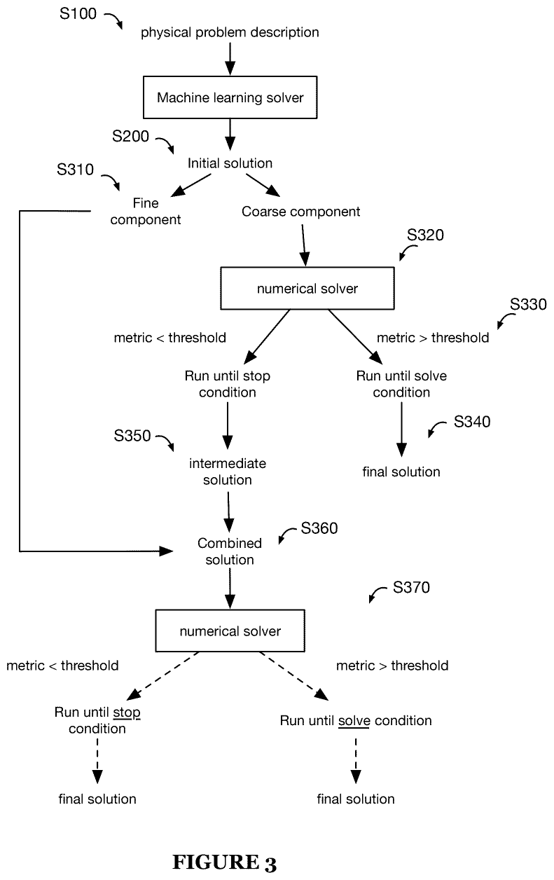

The combined solution (e.g., hybrid solution) can be a solution determined by combining the intermediate solution and the finer component, and/or otherwise determined, example shown in FIG. 3. The intermediate solution and the finer component can be combined by adding the fine component to the intermediate solution (e.g., using a weighted sum), overlaying the intermediate solution and the fine component, including the fine component with the intermediate solution when seeding in S370, performing an inverse transform of the intermediate solution and/or fine component out of the frequency domain (e.g., using an inverse Fourier transform, inverse wavelet transform, etc.) and performing the combination in the spatial domain, and/or any other suitable combination method.

Determining the combined solution can include additional processing steps such as smoothing, averaging, filtering, normalizing, upsampling, downsampling, weighting, and/or any other suitable processing steps.

In a first variant, S360 can include adding the intermediate solution and the fine component directly, where each is equally weighted, and/or any other suitable combination method. In a second variant, S360 can include determining a weighted sum of the intermediate solution and the fine component, wherein the weights can be determined based on the relative accuracy or trust in each component (e.g., based on a local residual error), and applying a smoothing across the weighted sum, and/or any other suitable combination method. In a third variant, S360 can include performing an inverse Fourier transform on the fine component, summing the transformed fine component with the intermediate solution in the spatial domain, and optionally normalizing the combined solution to ensure numerical stability, and/or performing any other suitable combination operations.

In variants in which S360 includes determining a weighted sum of the corrected coarse-scale component and the fine-scale component, the weights can be determined according to the local residual error at a given spatial location, voxel, node of the system. The local residual error can represent a measure of mismatch between a predicted value and a reference value governed by the equations of the physical problem. The local residual error can be computed during iterative solver. The local residual error can be a difference between the prediction and a physics-based constraint, a simplified solution, an observed measurement, or a consistency condition between hierarchical components. In variants, the local residual error is the difference between the left-hand side and right-hand side of a PDE equation when evaluated using the predicted solution. In illustrative examples, the local residual error can be computed per spatial cell, node, element, or neighborhood, and can be expressed as an absolute error, squared error, normalized error, or norm-based residual. Components exhibiting lower local residual error can be assigned higher weights relative to components exhibiting higher local residual error.

However, generating a combined solution by combining the intermediate solution with a finer component from the set of hierarchical components S360 may be otherwise performed.

In variants, the method can optionally include determining the final solution by repeating S320-S350 using the combined solution as a seed S370. Determining the final solution by repeating S320-S350 using the combined solution as a seed S370 functions to continue to solve for the final solution, using successively finer components of the initial solution to refine and expedite the solve. In variants, S370 can include repeating S320-S350.

During iterations of S370, S320 is preferably repeated using the combined solution as the seed in lieu of the coarse component, but can alternatively use the finer component as the seed, or use any other combination of intermediate solutions and hierarchical components as the seed. In variants, subsequent iterations of S370 can use combined solutions generated from the intermediate solution (from the prior iteration) and the successively finer component in the component hierarchy, and/or any other suitable solutions. The repeated instances of S320-S350 can be performed using the same or different default convergence conditions, premature convergence conditions, stop conditions, solver parameters, solvers, and/or other conditions or parameters.

In a first variant, S370 can include treating the intermediate solution output by the final iteration of S350 (e.g., the iteration of S350 that used the finest component as part of the seed for the solve) as the final solution to the physical problem. In a second variant, S370 can include determining the final solution by using the intermediate solution output by the final iteration of S350 as a final seed for a final solve by the numerical solver, and/or any other suitable determination method. However, determining the final solution by repeating S320-S350 using the combined solution as a seed S370 may be otherwise performed. In variants, repeating S320-S350 can be optional, wherein the combined solution (e.g., determined in 360) can be determined to be the final solution, and/or any other suitable determination method can be used.

However, determining a final solution of the physical problem description, using the initial solution as a seed S300 may be otherwise performed. In some variants, the final solution can be used to train the machine learning model (e.g., as a training target). For example, the final solution can be used as feedback to the model for subsequent predictions.

In an illustrative example, S300 can include performing a decomposition on the initial solution to produce a fine component and coarse component of the initial solution. The coarse component can be used as a seed for an iterative numerical solve to solve the physical problem. During iterations of the iterative solving process, each iterative solution can be assessed and/or evaluated to determine if the iterative solution satisfies a premature convergence condition and/or satisfies a stop condition. This can include comparing the iterative solution and/or a property of the iterative solution (e.g., derivative of the iterative solutions, residual norm, etc.) with a predetermined threshold. When the premature convergence condition is satisfied and/or when the stop condition is satisfied, the numerical solver can continue determining iterative solutions for a predetermined number of iterations. The last determined iterative solution can be referred to as the intermediate solution or a corrected coarse component. This corrected coarse component can be combined (e.g., aggregated, etc.) with the fine component to produce the combined solution. In some variants, the combined solution can be the final solution. In other variants, the combined solution can be used as a seed to the numerical solver to determine the final solution (e.g., iteratively solved until a stop and/or solve condition is met, etc.), such as when the solve condition is unmet, a convergence condition is unmet, a stop condition is unmet, and/or when other conditions are satisfied. In another specific example for determining a final solution, the coarse component can be used as a seed to the numerical solver and iteratively solved until a solve condition is satisfied. In these variants, the corrected coarse component can be the final solution and does not need to be combined with the fine component.

The method can optionally include training a machine learning model based on the final solution S400, functions to train and/or refine a machine learning model to more accurately predict the final solution, given the problem description. In variants, S400 functions to learn ML parameter values (e.g., weights, coefficients, biases, and/or any other suitable ML parameter values). S400 can be performed after a final solution is determined, after S100-S300, before S100, and/or at any other suitable time.

The model can be trained: trained end-to-end, piecewise (e.g., the encoding layers are trained independently of the decoding layers), or otherwise trained. The model can be trained using supervised learning, unsupervised learning, semi-supervised learning, reinforcement learning, transfer learning, and/or any other training method.

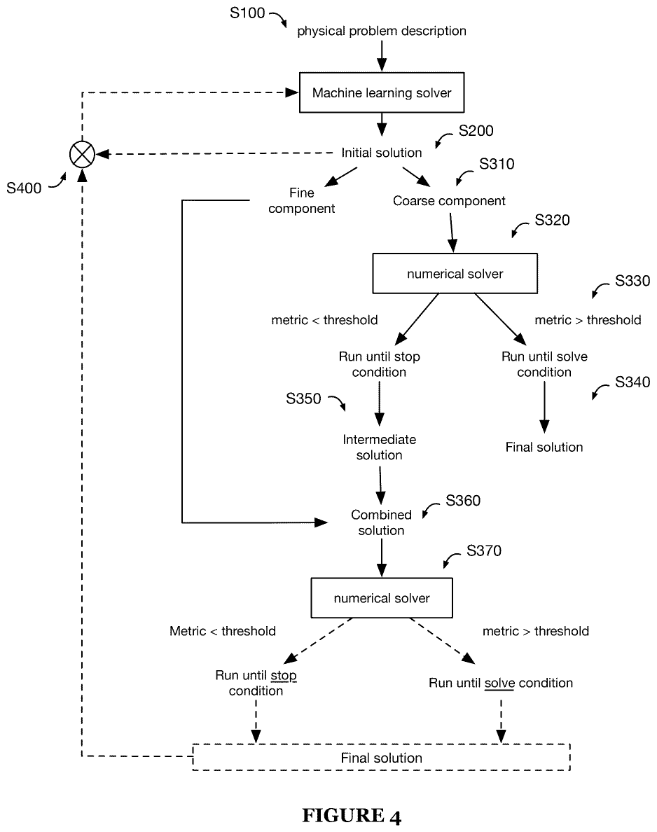

In variants, the machine learning model can be trained using a set of training data. The training data include a physical problem description and/or design, with a physical field as the training target. In variants, the final solution (e.g., determined in S300) can be the training target(example shown in FIG. 4). However, the model can be trained based on any other suitable parameters.

The machine learning model can be a multilayer perceptron, decision tree, support vector machine, neural network, deep neural network, CNN, GNN, transformer, and/or any other suitable machine learning model. The machine learning model can be the same model used to predict the initial guess in step S200 (e.g., to determine the initial solution), a second model, and/or any other suitable model configuration.

In variants, training can include optimizing model parameters (e.g., using backpropagation, gradient descent, etc.) based on input-output pairs (e.g., physical problem descriptions and final solutions) to improve the model's ability to predict solutions for similar physical problems, by minimizing a loss function, and/or any other suitable training methods.

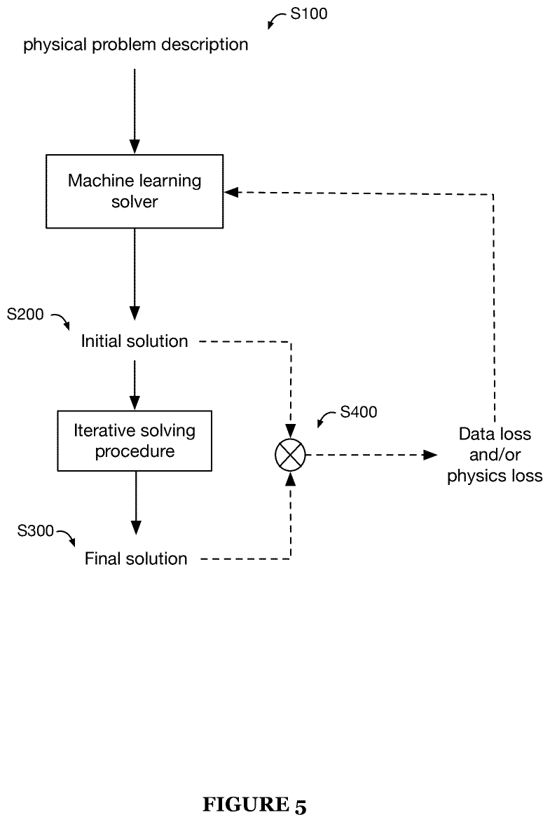

The loss function can include a physics loss (e.g., preconditioned loss, matrix-based preconditioned loss, loss computed using the governing partial differential equations for the physical characteristic; a loss function that penalizes violation of physics-based constraints; etc.), a data loss (e.g., loss computed by comparing the predicted output and a ground-truth value), gradient losses (e.g., gradient difference loss, gradient norm loss, Jacobian loss, seminorm losses, etc.), regression losses (e.g., MSE, MAE, Huber loss, quantile loss, etc.), classification losses (e.g., binary classification, multiclass classification, etc.), ranking losses (e.g., contrastive loss, triplet loss, etc.), divergence losses, autoencoder losses, normal consistency, Laplacian loss, cross-entropy losses, and/or any other losses, example shown in FIG. 5. The data loss can include a loss determined based on a comparison between the machine learning model's prediction of the physical problem description and the final solution (e.g., from S340 or S370). The physics loss can include a loss determined based on the machine learning model's prediction of the physical problem description and the governing equations. In an example, if the governing equation is Ax=b, the physics loss can be determined based on how different b is from Ax. The total loss can be a sum, weighted sum, average, and/or any other suitable combination of the data loss and physics loss. However, training a machine learning model based on the final solution S400 may be otherwise performed.

### 4. System

In variants, the system includes: a machine learning model 100; a decomposition module 200; a reconstruction module 300; and a solver 400, as shown for example in FIG. 2. The system functions to determine a physical state and/or property defined by a physical problem. The physical problem can include an object geometry, material properties, environment properties, boundary conditions, loading conditions (e.g., applied stimuli, such as stimuli kinematics, stimuli location, etc.), physics-based variable constraints, and/or any other physical problem characteristics.

The physical problem can include a physical design. The design can be, include, or represent a physical system (e.g., chip, chipset, assembly, fluidic system, physical space, time, etc.), computational domain, or any other suitable system. In an example, the physical design can include a set of information (e.g., parameters, coefficients, measurements, etc.) that is associated with a physical system. However, in variants, the physical design may not be associated with a physical system (e.g., is a theoretical idea and/or conceptualization, etc.). The design can be continuous, discontinuous, or have any geometry. The design can include a single component or multiple components. The design can include geometric features of multiple length scales (e.g., subatomic-scale, atomic-scale, molecular-scale, nanometer-scale, micron-scale, meso-scale, millimeter-scale, centimeter-scale, macro-scale, meter-scale, etc.). The design can include a solid body, a shell, perforated, and/or have any other topology. In an example, the design can include one or more internal layers (e.g., nested shells of gold, silver, copper, or any type of internal layer). The design can include a single material or multiple materials. For example, a design can have component made with polymers, metals, ceramics, semiconductors, or any other suitable material.

The design can include geometric information (e.g., geometric representations such meshes, point clouds, signed distance functions, etc., geometric embeddings, geometric encodings, etc.), topological information (e.g., persistence diagram, etc.), boundary conditions (e.g., Dirichlet, Neumann, Robin, etc.), source element information, material properties and/or physical properties, and/or any other information. The system's physical problem description can additionally or alternatively include solving parameters (ex. solver settings, step size, meshing, solve conditions). The physical problem description preferably excludes governing equations for variable of interest (e.g., the physical parameter being solved for), but can alternatively include governing equations for variable of interest.

The system can determine a physical field (e.g. states, properties, etc.). In variants, the physical field can represent an approximation of real-world physical phenomena across the design (e.g., design of a physical system), and can specify a spatially-and/or temporally-varying physical quantity (e.g., for the entire design, for individual spatial and/or temporal units of the design, for predefined regions of the design, etc.). In variants, the physical field can be represented as a set of numerical data (e.g., values for each voxel, values for each of a set of points, values for each time point, etc.), a visualization (e.g., contour plot, shape, animation, data plot, color-coded plot, etc.), and/or otherwise represented. The system can predict examples of physical state, properties, and/or fields that can include structural fields (e.g., stress, strain, deflection, displacement, buckling, stability, fatigue, fracture, vibration, acoustics, etc.), thermal fields (e.g., temperature distribution, heat flux, thermal stress, thermal expansion, radiative heat transfer, etc.), fluid fields (e.g., fluid dynamics, fluid flow, pressure distribution, velocity, turbulence, heat transfer, etc.), electromagnetic fields (e.g., electric field, magnetic field, electromagnetic induction, microwave analysis, RF analysis, etc.), geotechnical or porous fields (e.g., pore pressure field, saturation field, permeability field, soil displacement, etc.), quantum fields (e.g., wavefunction fields, spin fields, electron density fields, etc.), acoustic fields, chemical or biological fields (e.g., reactant/product distribution; chemical potential field, pH or ionic fields, membrane potential field, tissue growth fields, etc.), nonlinear behaviors (e.g., with complex stress-strain relationships), optical characteristics (e.g., refraction, transmission, etc.), and/or other characteristics.

The machine learning model 100 functions to determine an initial prediction to the physical problem. The machine learning model 100 can be a multilayer perceptron model, a neural network, a deep neural network, a convolutional neural network (CNN), a UNet, a recurrent neural network (RNN), a graph neural network, a transformer, a feed forward network, an autoencoder, a neural network with a set of self-attention layers or cross attention layers, ensembles thereof, and/or any other suitable machine learning model.

The machine learning model 100 can include an input layer, a dense layer, a linear layer, a bias layer, an embedding layer, a convolution layer (e.g., transposed convolution, depthwise convolution, separable convolution, dilated convolution, etc.), a pooling layer, an upsampling layer, a padding layer, a cropping layer, a recurrent layer, an LSTM layer, a GRU layer, a SimpleRNN layer, a Bidirectional RNN layer, a temporal convolution layer, an attention layer (e.g., multi-head attention layer, cross-attention layer, self attention layer, etc.), an encoder layer, a decoder layer, a feed-forward block, a normalization layer (e.g., batch normalization, layer normalization, group normalization, instance normalization, weight normalization, etc.), a dropout layer (e.g., spatial dropout, alpha dropout), an activation layer (e.g., ReLU, Leaky ReLU, ELU, GELU, Sigmoid, Tanh, Softmax, Softplus, etc.), a residual block, a skip connection, a graph layer, and/or any other layer.

The machine learning model can receive as input geometry information, topological information, boundary conditions, material properties and/or physical properties, source element information, loading information, and/or any other input. In variants, the machine learning model 100 can have a plurality of input channels to receive different data types. In variants, the machine learning model can have a plurality of input channels to receive different data types. For example, the machine learning model can have separate input channels for different types. Alternatively, the machine learning model can have a single input channel, combined input channels, and/or any other configuration. In variants, the machine learning model can have a plurality of input channels to receive different data types. Input can be passed to the machine learning model and/or aggregated in any suitable manner.

The machine learning model can generate (e.g., predict, output, compute, estimate, infer, etc.) a physical field, a confidence score, and/or any other suitable output. The physical field can include a physical characteristic value for each of a set of spatial and/or temporal units within the physical field, a solution to the respective governing equations, etc. In variants, the physical field can be represented as a vector, tensor, map, grid, and/or any other suitable form. The output of the machine learning model 100 can be at a uniform resolution or at varying resolutions (e.g., different resolutions for different regions of the design).

In variants, the machine learning model 100 can be trained with physical problem data as the training input and the associated physical field as the training target. For example, the machine learning model can be trained on physical designs for a range of objects and/or systems with associated thermal fields as the training target. In variants, final solutions determined in S300 can be used as training targets for training, re-training, and/or fine-tuning the machine learning models. In these variants, the final solution can be used in a feedback loop for training. The training target fields can be measured, determined mathematically, and/or otherwise determined. The training data for the machine learning model 100 can include: empirical data (e.g., physical measurements of physical systems), numerically solved physical fields, corrected solutions from prior physics model iterations (e.g., wherein the inferred physical field is corrected using a numerical solver), and/or any other training data (e.g., training target data). The machine learning model 100 can be trained end-to-end, in segments (e.g., separately train the encoder and decoder), and/or using any other suitable method. The machine learning model 100 can be trained using supervised learning, self-supervised learning, unsupervised learning, transfer learning (e.g., from a model trained for a different physics domain, length scale, etc.), reinforcement learning, and/or otherwise learned. The machine learning model 100 can be trained: once, iteratively (e.g., when a verifier provides a correct physical field), and/or at any other time. During training, the machine learning model 100 can learn a set of parameters (e.g., weights, coefficients, etc.) for each layer of the model. In variants, the set of parameters can define (e.g., approximate, estimate, describe, etc.) a neural operator. The machine learning model 100 can be trained on all possible inputs, a subset of inputs (e.g., using holdout method, dropout methods, etc.) or using any other method. The machine learning model 100 can be trained using one or more losses.

Examples of losses that the physics model can be trained on include data loss (e.g., ensures agreement with observational or ground-truth physical fields), physics loss (e.g., PDE residual loss; ensures the model's outputs satisfy the governing partial differential equations for the physics domain), initial condition loss (e.g., to enforce agreement with known initial states), boundary condition loss (e.g., penalizes violation of boundary constraints), gradient loss (e.g., enforces smoothness), conservation loss (e.g., penalizes deviations from conservation laws, such as mass, energy, momentum, etc.), constraint loss (e.g., enforces geometric constraints, such as non-negativity), region-specific losses (e.g., focuses the losses in certain spatial or temporal regions, such as interfaces), and/or any other losses.

However, the machine learning model 100 can be otherwise trained.

However, the machine learning model 100 may be otherwise configured.

The decomposition module 200 functions to decompose the prediction into hierarchical components. In variants, the decomposition module 200 can determine fine and coarse components of a field (e.g., a predicted field from the machine learning model). In variants, the decomposition module 200 can decompose the field into two resolutions (e.g., fine and coarse, dominant and residual, etc.), three resolutions (e.g., fine, medium, coarse), four resolutions, five resolutions, and/or any suitable amount of resolutions. In variants, the decomposition module 200 can perform a frequency-based transformation, a spatial decomposition, a modal decomposition, a statistical decomposition, data-driven decomposition, and/or any other suitable transformation or decomposition. The decomposition module can perform Fourier transform, Laplace transform, wavelet transform, normal mode decomposition, discrete cosine transform, multiscale decomposition, multi-resolution analysis, Gaussian pyramid decomposition, Laplacian pyramid decomposition, wavelet packet decomposition, variational mode decomposition, empirical mode decomposition, principal component analysis, dynamic mode decomposition, singular value decomposition, and/or any other transform or decomposition.

In variants, the decomposition module 200 can include transformation modules (e.g., for performing the mathematical transformation), a filtering module (e.g., for selecting dominant modes, for aggregating the decompositions into the desired resolutions, etc.), and/or any other suitable modules. The decomposition module 200 can operate recursively (e.g., hierarchical decomposition, etc.), in parallel (e.g., multi-resolution streams, etc.), and/or in any suitable manner. The input of the decomposition module can be a field, a predicted field (e.g., from the ML model), and/or any other input. The output of the decomposition module can be one or more component fields (e.g., fine component, coarse component), a frequency-domain representation, basis coefficients, reconstruction weight, and/or any other output. In variants, the decomposition module 200 can be an analytical solver, mathematical solver, algorithmic module, signal processing module, and/or any other suitable module. However, in other variants the decomposition module 200 can be machine learning model (e.g., neural network, autoencoder, etc.). However, the decomposition module 200 may be otherwise configured.

The reconstruction module 300 functions to recompose a field from components (e.g., from the decomposition module). The reconstruction module 300 can combine, aggregate, sum, average, weighting, and/or otherwise reassembles the hierarchical components of the predicted field. In variants, the reconstruction module 300 can modify, weight, and/or filter the components. In variants, the reconstruction module 300 can perform interpolation, upsampling, and/or downsampling prior to aggregating the components. The reconstruction module 300 preferably determines a summation of the components, but can additionally and/or alternatively be otherwise configured. However, the reconstruction module 300 may be otherwise configured.

The solver 400 functions to tune the prediction into a final solution. The solver (e.g., numerical solver, etc.) can receive a field prediction as input and determine a final solution. The solver 400 can be a direct solver, iterative solver, explicit, implicit, hybrid and/or any other suitable solver. In variants, the solver 400 can adaptively refine a grid and/or resolution of the final solution. Examples of solvers can solve for the final solution by performing Gaussian elimination, LU decomposition, Cholesky decomposition, Jacobi iteration, Gauss-Seidel iteration, Successive over-relaxation (SOR), Conjugate Gradient (CG), BiCGSTAB (Bi-Conjugate Gradient Stabilized), GMRES (Generalized Minimal Residual), Multigrid methods, and/or any other methods. However, the solver 400 may be otherwise configured.

### 5. Specific Examples

Specific Example 1. A method comprising: receiving a description of a physical problem; using a machine learning model, determining a field prediction based on the description; determining a coarse-scale component and a fine-scale component of the field prediction; using a numerical solver, computing a corrected coarse-scale component; and determining a final field for the physical problem comprising aggregating the corrected coarse-scale component and the fine-scale component.

Specific Example 2. The method of Specific Example 1, wherein computing the corrected coarse-scale component comprises: seeding the numerical solver with the coarse-scale component of the field prediction; iteratively updating the coarse-scale component with the numerical solver; and when the updated coarse-scale component has satisfied a convergence condition or when a stop condition is satisfied, halting iterative updating and assigning the updated coarse-scale component as the corrected coarse-scale component.

Specific Example 3. The method of Specific Example 3, wherein the stop condition comprises a threshold number of iterations.

Specific Example 4. The method of Specific Example 1, wherein the corrected coarse-scale component does not meet a convergence condition.

Specific Example 5. The method of Specific Example 1, wherein the description comprises an object geometry, a set of material properties, and a set of boundary conditions.

Specific Example 6. The method of Specific Example 1, further comprising training the machine learning model, comprising computing a physics-based loss and a data loss.

Specific Example 7. The method of Specific Example 6, wherein training the machine learning model comprises training the machine learning model on a set of training problem descriptions, wherein the set of training descriptions comprise geometric resolutions that span five or more magnitudes.

Specific Example 8. The method of Specific Example 1, wherein determining the field prediction comprises encoding the description into a set of non-human readable latent encodings

Specific Example 9. The method of Specific Example 1, wherein determining the coarse-scale component and fine-scale component comprises performing a multiresolution transform of the field prediction.

Specific Example 10. The method of Specific Example 1, wherein aggregating the corrected coarse-scale component and the fine-scale component comprises weighting the corrected coarse-scale component and the fine-scale component according to a local residual error.

Specific Example 11. The method of Specific Example 1, further comprising providing the final field as feedback to the machine learning model for subsequent predictions, comprising training the machine learning model with the final field as a training target.

Specific Example 12. The method of Specific Example 1, wherein the final field comprises a heat flux field.

Specific Example 13. A system comprising: a non-transitory computer-readable medium storing a set of instructions; a processing system configured to execute the set of instructions to: receive a description of a physical problem, the description comprising an object geometry, a set of material properties, and a set of boundary conditions; determine a field prediction based on the description using a machine learning model; decompose the field prediction into a coarse-scale component and a fine-scale component; compute a corrected coarse-scale component using a numerical solver; and aggregate the corrected coarse-scale component and the fine-scale component to determine a final field for the physical problem

Specific Example 14. The system of Specific Example 13, wherein computing the corrected coarse-scale component comprises: iteratively computing updated coarse-scale components; and prematurely stopping the numerical solver before the corrected coarse-scale component is fully converged when a stop condition is met.

Specific Example 15. The system of Specific Example 13, wherein the machine learning model is trained using a combination of a physics-based loss and a data-driven loss.

Specific Example 16. The system of Specific Example 15, wherein the physics-based loss comprises a preconditioned physics-based loss.

Specific Example 17. The system of Specific Example 13, wherein the stop condition comprises a threshold number of iterations.

Specific Example 18. The system of Specific Example 13, wherein the field prediction is determined from a set of latent encodings of the description, wherein the set of latent encodings are not human readable.

Specific Example 19. The system of Specific Example 13, wherein the field prediction is decomposed into the coarse-scale component and fine-scale component using a frequency-based transform of the field prediction.

Specific Example 20. The system of Specific Example 13, wherein the final field comprises at least one of a heat flux field, stress field, strain field, fluid flow field, velocity field, electric field, or magnetic field.

Specific Example 21. The system of Specific Example 13, wherein the machine learning model comprises a transformer architecture including a plurality of attention layers.

Specific example 22. The system of Specific Example 13, wherein computing the corrected coarse-scale component comprises iteratively computing updated coarse-scale components; determining whether each updated coarse-scale component satisfies a stop condition; and when the stop condition is met, prematurely stopping the numerical solver before the corrected coarse-scale component is fully converged.

Optional elements, which can be included in some variants but not others, are indicated in broken line in the figures.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method comprising:
receiving a description of a physical problem;
using a machine learning model, determining a field prediction based on the description;
determining a coarse-scale component and a fine-scale component of the field prediction;
using a numerical solver, computing a corrected coarse-scale component; and
determining a final field for the physical problem comprising aggregating the corrected coarse-scale component and the fine-scale component.

2. The method of claim 1, wherein computing the corrected coarse-scale component comprises:
seeding the numerical solver with the coarse-scale component of the field prediction;
iteratively updating the coarse-scale component with the numerical solver; and
when the updated coarse-scale component has satisfied a convergence condition or when a stop condition is satisfied, halting iterative updating and assigning the
updated coarse-scale component as the corrected coarse-scale component.

3. The method of claim 2, wherein the stop condition comprises a threshold number of iterations.

4. The method of claim 1, wherein the corrected coarse-scale component does not meet a convergence condition.

5. The method of claim 1, wherein the description comprises an object geometry, a set of material properties, and a set of boundary conditions.

6. The method of claim 1, further comprising training the machine learning model, comprising computing a physics-based loss and a data loss.

7. The method of claim 6, wherein training the machine learning model comprises training the machine learning model on a set of training problem descriptions, wherein the set of training descriptions comprise geometric resolutions that span five or more magnitudes.

8. The method of claim 1, wherein determining the field prediction comprises encoding the description into a set of non-human readable latent encodings.

9. The method of claim 1, wherein determining the coarse-scale component and fine-scale component comprises performing a multiresolution transform of the field prediction.

10. The method of claim 1, wherein aggregating the corrected coarse-scale component and the fine-scale component comprises weighting the corrected coarse-scale component and the fine-scale component according to a local residual error.

11. The method of claim 1, further comprising providing the final field as feedback to the machine learning model for subsequent predictions, comprising training the machine learning model with the final field as a training target.

12. The method of claim 1, wherein the final field comprises a heat flux field.

13. A system comprising:
a non-transitory computer-readable medium storing a set of instructions;
a processing system configured to execute the set of instructions to:
receive a description of a physical problem, the description comprising an object geometry, a set of material properties, and a set of boundary conditions;
determine a field prediction based on the description using a machine learning model;
decompose the field prediction into a coarse-scale component and a fine-scale component;
compute a corrected coarse-scale component using a numerical solver; and
aggregate the corrected coarse-scale component and the fine-scale component to determine a final field for the physical problem.

14. The system of claim 13, wherein computing the corrected coarse-scale component comprises:
iteratively computing updated coarse-scale components; and
prematurely stopping the numerical solver before the corrected coarse-scale component is fully converged when a stop condition is met.

15. The system of claim 13, wherein the machine learning model is trained using a combination of a physics-based loss and a data-driven loss.

16. The system of claim 15, wherein the physics-based loss comprises a preconditioned physics-based loss.

17. The system of claim 13, wherein the stop condition comprises a threshold number of iterations.

18. The system of claim 13, wherein the field prediction is determined from a set of latent encodings of the description, wherein the set of latent encodings are not human readable.

19. The system of claim 13, wherein the field prediction is decomposed into the coarse-scale component and fine-scale component using a frequency-based transform of the field prediction.

20. The system of claim 13, wherein the final field comprises at least one of a heat flux field, stress field, strain field, fluid flow field, velocity field, electric field, or magnetic field.
